(19) United States
(12) Patent Application Publication
(10) Pub. No.: US 2015/0169596 A1
(43) Pub. Date: Jun. 18, 2015

(54) DETERMINING EVENT ORIGIN

(71) Applicant: Google Inc., (US)

(72) Inventor: Justyna Sidorska, Erlenbach (CH)

(73) Assignee: Google Inc., Mountain View, CA (US)

(21) Appl. No.: 13/770,437

(22) Filed: Feb. 19, 2013

(51) Int. Cl. G06F 17/30

(52) U.S. Cl. CPC G06F 17/3087; G06F 17/30241

(57) ABSTRACT

Methods, systems, and apparatus, including computer programs encoded on computer storage media, for determining image search results. One of the methods includes receiving a query from a client device and determining that the query is a recurrent query, wherein a recurrent query is a query that is predominantly received from a particular geographic region during a particular time period. The location of the client device is determined based at least in part on the particular geographic region.

### BACKGROUND

This specification relates to estimating geographic origins of network traffic.

Internet search engines provide search results for Internet accessible resources, e.g., web pages, images, audio content, maps, text documents, multimedia content, and other digital content, that are responsive to users' search queries. The search results can be ranked according to scores assigned to the search results by a scoring function, for instance. A search result generally includes a link to the corresponding resource, e.g., a Uniform Resource Locator (URL) for the resource and may include a snippet of text or an image taken from the resource. A user can formulate a query in the form of text, an image, or a user interaction with an interactive map, for example. Other types of queries are possible.

Geocoding is the process of determining geographic coordinates, e.g., latitude and longitude, from other types of data such as street addresses, zip codes, and Internet Protocol (IP) addresses. Some search engines can use data generated by geocoding systems to tailor search results to users' geographic locations.

### SUMMARY

This specification describes how a system can use recurrent queries to determine a geographic location or area from which a particular search query originated. Recurrent queries are queries that exhibit significant traffic, i.e., a “query peak” or “spike,” during a particular recurring time period and from one or more particular geographic locations. For example, traffic for the query “mother's day” is likely to exhibit a spike for queries originating in the United States during the second week of May.

After identifying multiple recurrent search queries, a search system can use the recurrent search queries to help determine the geographic origin of received queries. For example, if the search system receives the query “mother's day” during the second week of May, it is likely that a user who submitted the query is located in the United States.

In general, one innovative aspect of the subject matter described in this specification can be embodied in methods that include the actions of receiving a query from a client device; determining that the query is a recurrent query, wherein a recurrent query is a query that is predominantly received from a particular geographic region during a particular time period; and determining the location of the client device based at least in part on the particular geographic region. In general, another innovative aspect of the subject matter described in this specification can be embodied in methods that include the actions of identifying, from a log of received queries, a plurality of queries related to a candidate recurrent query; determining a plurality of counts from the plurality of queries, each count representing a number of times the queries were received from one of a plurality of geographic regions and during one of a plurality of time periods; identifying a peak count among the plurality of counts, the peak count satisfying peak count criteria and representing a number of times the queries were received from a first geographic region during a first time period; and determining that the candidate recurrent query is a recurrent query during the first time period for the first geographic region. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Identifying a peak count among the plurality of counts further comprises determining that a ratio of a count among the plurality of counts to the average count among the plurality of counts is greater than a threshold. Identifying a peak count from among the plurality of counts includes determining a probability distribution from the plurality of counts, each probability in the probability distribution representing the probability of receiving queries from the plurality of queries from one of the plurality of geographic regions during one of the plurality of time periods; determining that an entropy of the probability distribution exceeds a threshold; and identifying a geographic region and a time period having a highest probability in the probability distribution. The plurality of queries are identical queries. The plurality of queries are similar queries. Determining a plurality of counts comprises determining the counts at different levels of geographic region granularity or different levels of time period granularity. The actions include receiving a search query from a client device; determining that the search query is similar to the candidate recurrent query; determining that the search query was received during the first period of time; and determining that the client device is located in the first geographic region.

Particular embodiments of the subject matter described in this specification can be implemented so as to realize one or more of the following advantages. Identifying recurrent queries provides an additional reliable signal for geolocating received search queries. Using recurrent queries to geolocate search queries increases the confidence and robustness of the geolocation system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example search system.

FIGS. 2A-2D are histograms that illustrate recurrent queries.

FIG. 3 is a flow chart of an example process for identifying particular queries as recurrent queries.

FIG. 4 is a flow chart of an example process for geolocating a query that is recognized as a recurrent query.

Like reference numbers and designations in the various drawings indicate like elements.

### DETAILED DESCRIPTION

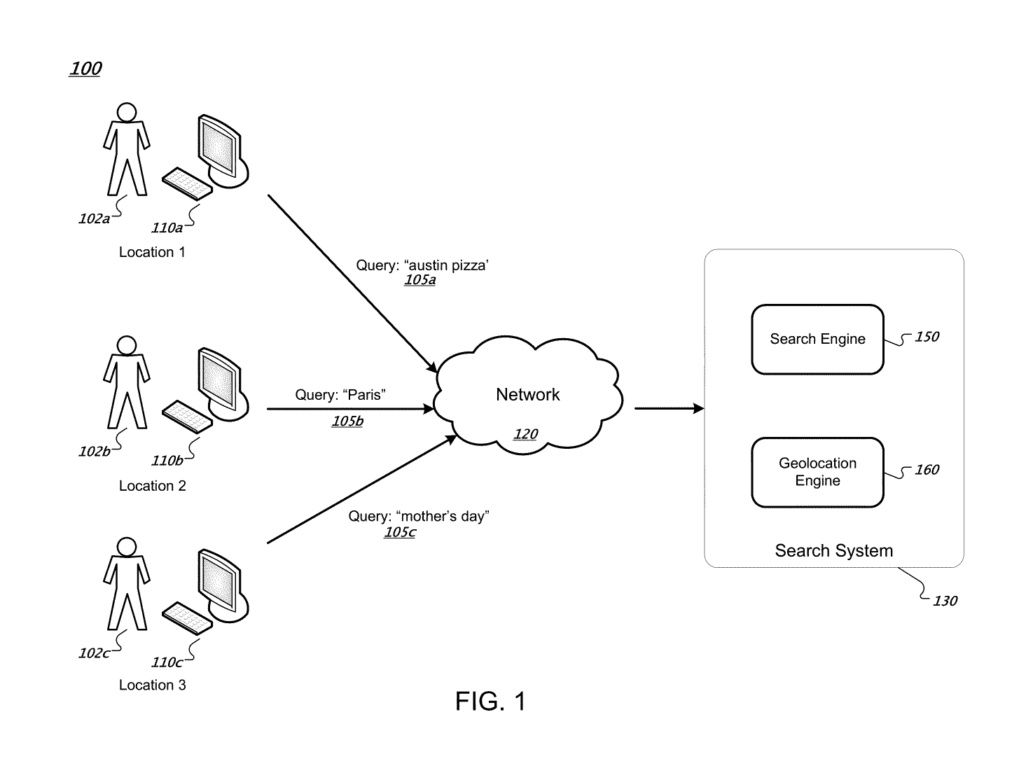

FIG. 1 is a diagram of an example search system 110. The search system 110 is an example of an information retrieval system in which the systems, components, and techniques described below can be implemented.

One or more user devices 110 can be coupled to the search system 130 through a data communication network 120. In general, in response to a user action, a user device transmits a query 105 over the network 120 to the search system 130. The search system 130 responds to the query 105 by generating a presentation of search results, e.g., a search results page, which is transmitted over the network 120 to the user device 110 in a form that can be presented on the user device 110, e.g., that can be displayed in a web browser on the user device 110. For example, the search results page can be a markup language document, e.g., HyperText Markup Language or eXtensible Markup Language document. The user device 110 renders the document, e.g., using a web browser, in order to present the search results page on a display device.

The user devices 110a-c can be any appropriate type of computing device, e.g., a server, mobile phone, tablet computer, notebook computer, music player, e-book reader, laptop or desktop computer, PDA (personal digital assistant), smart phone, or other stationary or portable device, that includes one or more processors for executing program instructions and memory. The user devices 110a-c can include computer readable media that store software applications, e.g., a browser or layout engine, an input device, e.g., a keyboard or mouse, a communication interface, and a display device.

The network 120 can be, for example, a wireless cellular network, a wireless local area network (WLAN) or Wi-Fi network, a Third Generation (3G) or Fourth Generation (4G) mobile telecommunications network, a wired Ethernet network, a private network such as an intranet, a public network such as the Internet, or any appropriate combination of such networks.

The search system 130 can be implemented as computer programs installed on one or more computers in one or more locations that are coupled to each other through a network, e.g., network 120. The search system generally includes a search engine 150 and a geolocation engine 160.

When a query 105 is received by the search system 130, the search engine 150 searches an index to identify resources that satisfy the query 105. The search engine 130 will generally also include a ranking engine that generates scores for the resources that satisfy the query 105. The search engine 150 can rank the resources, e.g., assign a sequential order in which the resources should be presented to a user 102, according to their respective scores. The search engine 130, ranking engine, and geolocation engine 160 can each be implemented as one or more software modules installed on one or more computers in one or more locations.

The geolocation engine 160 can classify queries as originating from one or more geographic regions. The geolocation engine 160 can use a variety of data sources to determine the geographic origin of a received search query. For example, search queries often include terms that are names of geographic locations, e.g., “austin pizza,” which may refer to Austin, Tex., or any of a number of other locations called “Austin.” A search query can also be associated with a geographic region corresponding to a region shown on a map presented by computing device that sends the query. Network requests other than search queries can also identify geographic locations, for example, received requests for driving directions to or from a particular geographic location, current location information provided by a device, e.g., a mobile device, or a user indication of a default geographic location.

For example, the geolocation engine 160 can compute a score representing a measure of confidence that a received query originated from a particular geographic region. The geolocation engine 160 can classify received queries according to an IP address of the query, particular terms in the query, query metadata, including user profile data and location-based services, in addition to many other types of data. For example, the geolocation engine 160 can determine that queries including the terms “mother's day” received during the second week of May are likely to have originated from the United States. The geolocation engine 160 can classify queries at varying levels of granularity, e.g., to a particular country, state or province, ZIP code, and so on.

The geolocation engine 160 can use the geographic locations associated with search queries to identify particular queries as recurrent queries and can use identified recurrent queries to determine one or more geographic regions from which the queries likely originated, as will be described in more detail below.

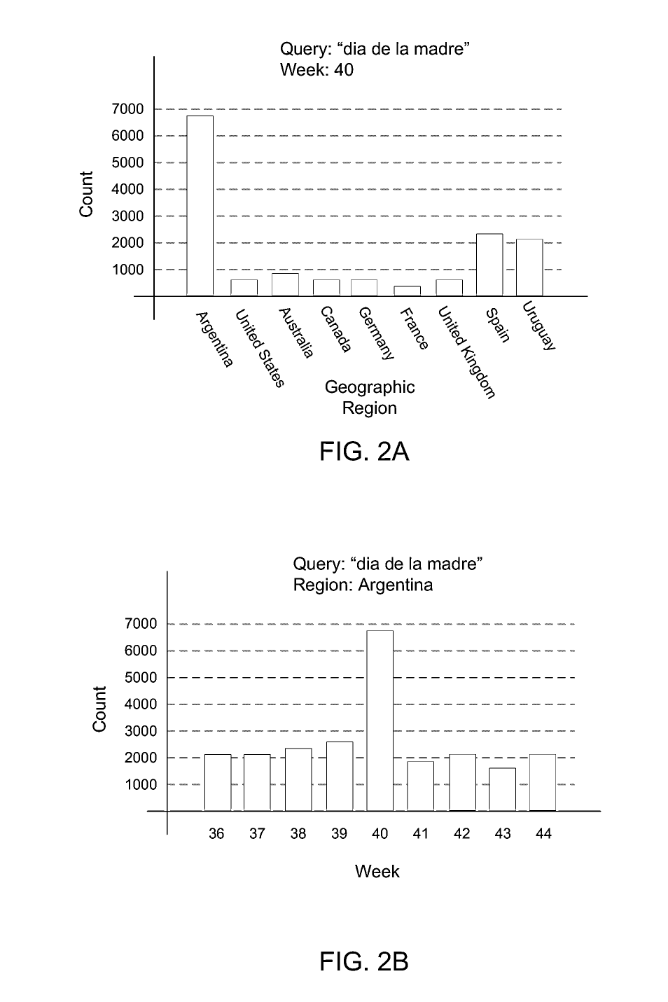

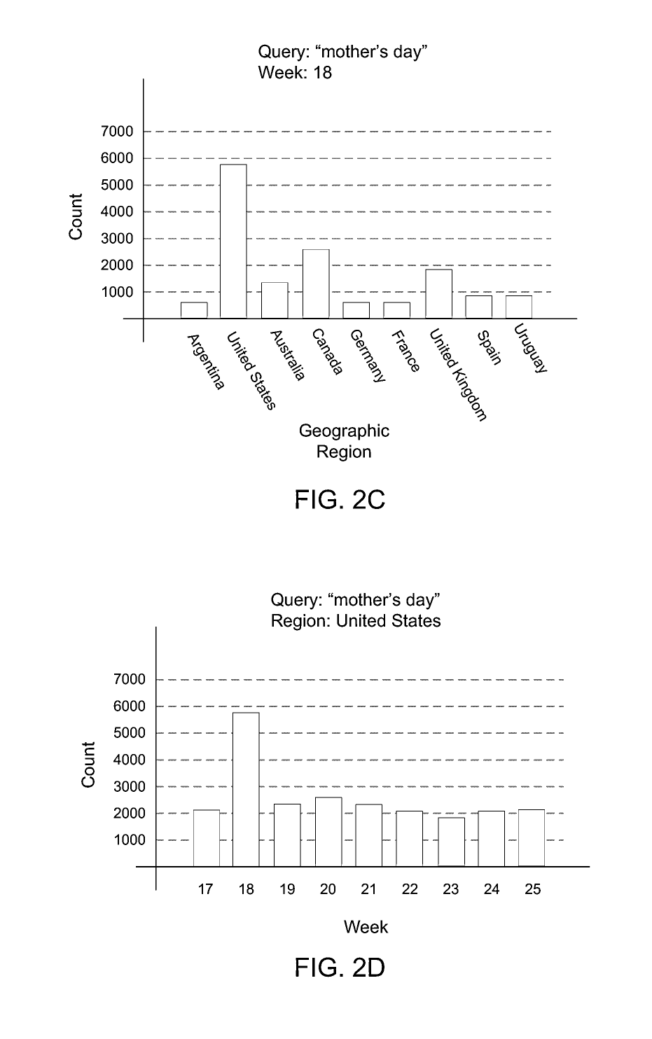

FIGS. 2A-2D are histograms that illustrate recurrent queries. In general, a search system considers both the geographic region associated with a query and the time period during which the query is received in order to identify recurrent queries. FIG. 2A is a histogram for the query “dia de la madre” received during week 40 from several geographic locations. The histogram shows that a significant number of queries “dia de la madre” are received from Argentina during week 40. FIG. 2B is a history for the query “dia de la madre” received from Argentina over the course of several weeks. The histogram shows that a significant number of queries “dia de la madre” are received from Argentina during week 40. Therefore, a search system can determine that “dia de la madre” has a query peak for the geographic region of Argentina and that “dia de la madre” peaks during week 40. Thereafter, if the search system receives the query “dia de la madre” during week 40, the system can increase a measure of confidence indicating that the query is likely to have originated from Argentina.

FIG. 2C is a histogram for the query “mother's day” received during week 18 from several geographic locations. A significant number of queries “mother's day” are received from the United States during week 18. FIG. 2D is a histogram for the query “mother's day” received from the United States over the course of several weeks. The history shows that a significant number of queries “mother's day” are received from the United States during week 18. Therefore, the search system can determine that “mother's day” is a recurrent query for the geographic region of the United States and that “mother's day” recurs during week 18. Thereafter, if the system receives the query “mother's day” during week 18, the system can determine that the query is likely to have originated from the United States.

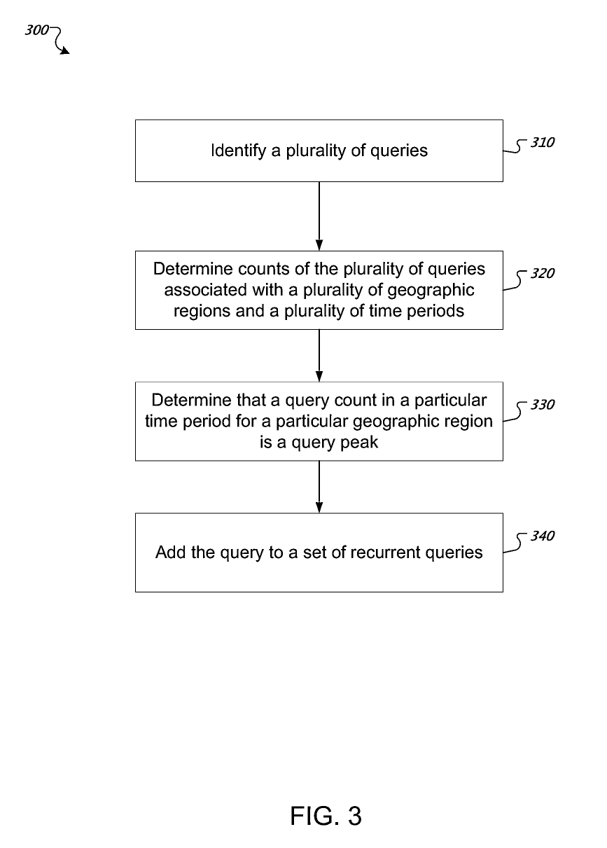

FIG. 3 is a flow chart of an example process 300 for identifying particular queries as recurrent queries. The process 300 analyzes query counts for a query originating from a particular geographic region during a particular recurrent time period. For convenience, the process 300 will be described as being performed by a computing system of one or more computers.

The system identifies a plurality of queries (310). The system can access query log data that indicates a geographic region and a time period for each query. For example, from a query log, the system can identify all occurrences of the query “dia de la madre” that are associated with Argentina. In some implementations, the geographic region determinations obtained from the query log were made by a geolocation engine according to a trained classifier.

The system determines counts of the plurality of queries associated with a plurality of geographic regions and a plurality of time periods (320). For a particular time period and a particular query, the system can compute counts of occurrences of the query received from each of multiple geographic regions. The counts can be raw occurrence counts for the query during the time period, e.g. during a particular week. The counts can also be an average of occurrences of the query during other previous time periods, e.g. an average of occurrences of the query during a particular week over previous years. The occurrence counts can be computed and tallied in real time, obtained from query log data, or obtained from other sources. The time periods considered can be of equal or varied length. In some implementations, the system divides the calendar year into a multiple time periods, e.g., months or weeks.

In some implementations, the system identifies and computes occurrence counts for clusters of similar or related queries, rather than computing counts only for identical queries. For example, the system can cluster related queries “turkey recipe” and “good recipe for turkey” and compute an aggregate count of occurrences of both queries. The system can generate clusters of similar or related queries using conventional methods, for example by using synonym substitutions, spelling corrections, or alternative spellings.

The system determines that a query count in a particular time period for a particular geographic region is a query peak (330). In general, the system can determine that a query count for a geographic region and a time period is a query peak if it satisfies peak count criteria, namely if it peaks both in time and by location. In other words, the system can compute query count statistics in order to determine whether a query count in a particular time period and for a particular geographic region is a query peak.

To do so, the system can compute a first measure of query peak strength for the particular time period when compared to counts of other geographic regions during that time period, and the system can also compute a second measure of query peak strength of the query count for the particular time period when compared to query counts in other time periods for the same geographic region. The system may then determine that a query is a recurrent query if the first measure and second measure of query peak strength satisfy respective thresholds.

To determine the query peak strength of a particular query count, the system can compare the query count for a first time period or a first geographic region to an average count for other time periods or other geographic regions as appropriate. For example, the system can compute a ratio between a query count and an average query count, or the system can compute a difference between a query count and an average query count. If the ratio or difference satisfies a threshold, the system can determine that the measure of query strength satisfies a threshold and that therefore, the query count is a query peak.

For example, the system can determine that the raw count for the query “turkey recipe” received from the United States during week 43 is 7000 occurrences and that the average weekly count is 500 occurrences. The system can then compute a measure of query peak strength by computing a ratio of 7000 to 500. The system can then compare the ratio to a threshold.

The system can also determine that a query peak occurs by computing an entropy score of a probability distribution for the query over either time periods or geographic locations. For example, in a particular time period, the system can compute probabilities that the query was received from each of multiple geographic locations. Each probability can be based on the raw query counts Tₖ for each of N geographic locations during a time period. The system can compute the probability for a particular geographic location P(xₖ) during the time period as:

$$P ( {x}_{k} ) = \frac{{T}_{k}}{{\sum }_{i = 1}^{N} {T}_{i}} .$$

In some implementations, the system adjusts the probabilities according to the respective populations of the geographic regions under consideration.

The computed probabilities P(xₖ) form a location probability distribution for the query during the particular time period. The system can determine whether the query is a recurrent query in one or more geographic locations by computing an entropy score for the location probability distribution. In some implementations, the entropy score H(X) for probability distribution X is given by:

$$H ( X ) = - {\sum }_{i = 1}^{N} P ( {x}_{i} ) log P ( {x}_{i} ) .$$

The system can then compare the entropy score H(X) to a threshold, which may be determined empirically. If the entropy score satisfies the threshold, the system can determine that one or more query counts are query peaks. For example, the system can determine that one or more geographic locations with the highest probabilities P(xₖ) are geographic regions for which the query counts are peaks. In a similar way, by computing the entropy of a distribution showing the probability of receiving a given query at a particular location as a function of time, the system can determine that the given query is a recurrent query for that location in one or more particular time periods when the entropy score exceeds a threshold.

The system can loop over time periods and geographic regions in any appropriate order to compute the query count statistics in order to identify query peaks. For example, the system can examine query counts in a first time period for multiple geographic regions. If a query peak occurs for a particular geographic region in the first time period, the system can then loop over other time periods to determine whether the query count for that geographic region and time period is also a query peak for other time periods. The system can then continue to examine other time periods in this way until query counts in all time periods and geographic regions have been examined. After identifying a query count that peaks in time and by location, the system can determine that the query is a recurrent query.

The system can also compute a measure of confidence for an identified recurrent query. The measure of confidence can be expressed as a score or as a probability, for example. The measure of confidence can be based on the measure of strength for the query peak in the relevant time period. The measure of confidence can also be based on a number of geographic regions for which the query is also a recurrent query during the particular time period. In other words, the measure of confidence can be based on a number of geographic regions for which the strength of the query peak satisfies a threshold during the time period. For example, the query “boxing day” may exhibit a significant query peak in December for queries received from England and Canada. Therefore, the system can determine a lower measure of confidence for both England and Canada than the measure of confidence for only England or only Canada. The system can distribute a measure of confidence equally between multiple geographic regions or the system can compute a measure of confidence for each region based on the respective strength of the query peak for each region. In some implementations, the system computes a probability distribution X for the multiple geographic regions such that individual probabilities assigned to each region for which the query is recurring sum to no more than 1.

On the other hand, if the query is a recurrent query for only one geographic region, the system can allocate the entire measure of confidence to that one region. In some implementations, the measure of confidence for a query being recurrent for a single geographic region is assigned a high probability, e.g., 0.85, 0.90, 0.95, or 1.0.

Some queries, for example the query “christmas songs,” may have a substantial increase in traffic in a particular time period, e.g., December, in many countries. The occurrence in many countries diminishes the ability of a recurrent query to differentiate one geographic region from another. Therefore, before determining that a query is a recurrent query for multiple geographic regions, the system can impose a maximum on the number of geographic regions for which the query can be considered recurrent.

The system can alter the number of geographic regions for which a particular query is considered recurrent by varying the granularity of the geographic regions considered. For example, the system can increase the geographic region granularity, e.g., from ZIP code to state, to decrease the number of geographic regions for which the query is a recurrent query. In some implementations, the system increases the geographic region granularity if the query is a recurrent query for too many, e.g., more than two, three, or five, geographic regions. Likewise, the system can decrease the geographic region granularity, e.g., from country to state, to increase the number of geographic regions for which the query is a recurrent query.

The system can also alter the number of time periods considered. For example, the system can increase or decrease the length of the time periods, which increases or decreases the strength of the query peaks in each time period. For example, the system can increase the time period length from one week to two weeks to one month.

The system can also alter the thresholds for each geographic region based on the strength of query peaks in other geographic regions. For example, to be a recurrent query, the system can require the measure of strength for a query peak in first geographic region to be twice as strong as the next-highest measure of strength for a query peak in a second geographic region.

The system can also alter the thresholds for a geographic region based on the strength of query peaks in other time periods. For example, the system can require the measure of strength for a query peak in first time period to be twice as strong as the next-highest measure of strength for a query peak in a second time period.

The system adds the query to a set of recurrent queries (340). The system can add the query, or cluster of similar or related queries, to a set of recurrent queries to be used by a geolocation engine when determining the origin of a particular query. The system can associate a recurrent query with a time period in which the query peaked and the geographic region from which it peaked. The system can also associates a recurrent query with a time period and multiple geographic regions, each geographic region having a respective measure of confidence.

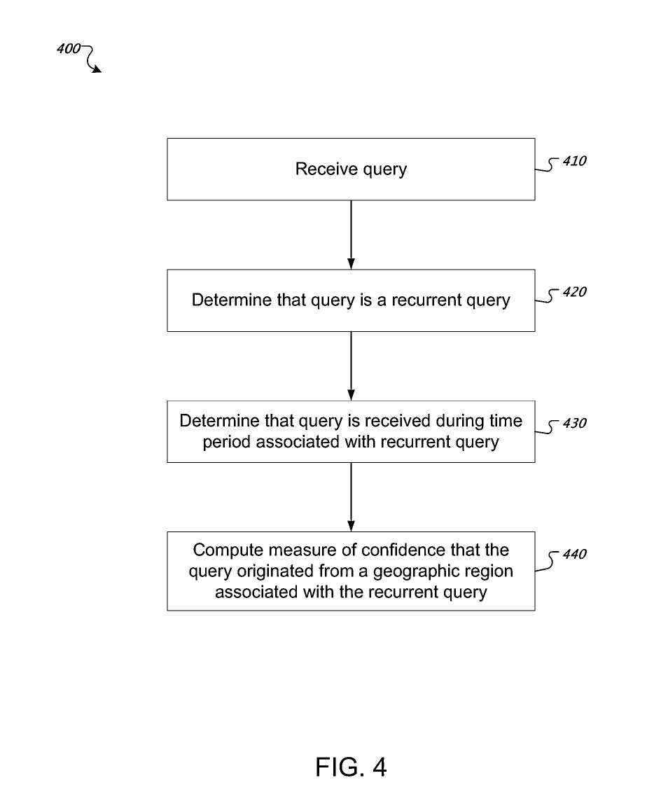

FIG. 4 is a flow chart of an example process 400 for geolocating a query that is recognized as a recurrent query. The process 400 will be described as being performed by a computing system of one or more computers.

The system receives a query (410). The system determines that the query is a recurrent query (420). The system can compare the terms of the received query to a precomputed set of recurrent queries to determine that the query is a recurrent query. The system can also determine that the query belongs to a cluster of similar related queries that are recurrent, e.g., “turkey recipe” and “recipe for turkey.”

The system determines that the query was received during a time period associated with the recurrent query (430).

The system computes a measure of confidence that the query originated from a geographic region associated with the recurrent query (440). The system can use the measure of confidence for the geographic region associated with the recurrent query to determine from where the query originated. In some implementations, the system can output the measure of confidence for the geographic region as a measure of confidence that the query originated from that geographic region. The system can output a probability distribution X over a number of geographic regions, as described above, where each geographic region has an associated probability that the query originated in that geographic region.

The system can use the measure of confidence associated with the recurrent query to adjust the results of a trained classifier. For example, geographic locations specified in search queries can be used to train a first classifier that computes a first probability P(q|loc) that a particular query q will be received from users in a given geographic region loc. Given these first probabilities, a second classifier, e.g., one that implements an expectation maximization algorithm, can be used to derive a probability P(loc|IP_block) that a query originated from a computing device in the geographic region loc, given that the query's IP address in the IP address block IP_block. These second probabilities can be used to compute a probability distribution Y over a number of geographic regions. The system can use the measure of confidence or probability distribution X for one or more geographic regions associated with the recurrent query to alter the probability of the corresponding geographic region. In some implementations, the increase in the probability is based on the respective measure of confidence associated with each geographic region of the recurrent query.

In some implementations, the system can use the probability distribution X associated with the recurrent query as input to a linear combination of classifiers, for example using an Adaptive Boosting algorithm. For example, the probability distribution Y output for an IP address block by an expectation maximization algorithm classifier can be used as a first input classifier, and the probability distribution X associated with the recurrent query can be used as a second input classifier. The Adaptive Boosting algorithm can use a plurality of training examples, e.g., queries labeled with their respective geographic region of origin, to compute a respective weight for each classifier in order to generate an overall classifier that is a combination of the first classifier and the second classifier. The overall classifier can then be used to compute a probability that the query originated from a particular geographic region.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

The term “engine” refers to one or more software modules implemented on one or more computers in one or more locations that collectively provide certain well-defined functionality, which is implemented by algorithms implemented in the modules. The software of an engine can be an encoded in one or more blocks of functionality, such as a library, a platform, a software development kit, or an object. An engine can be implemented on any appropriate types of computing devices, e.g., servers, mobile phones, tablet computers, notebook computers, music players, e-book readers, laptop or desktop computers, PDAs, smart phones, or other stationary or portable devices, that includes one or more processors and computer-readable media. Additionally, two or more engines may be implemented on the same computing device or devices.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a query from a client device;
determining that the query is a recurrent query, wherein a recurrent query is a query that is predominantly received from a particular geographic region during a particular time period; and
determining the location of the client device based at least in part on the particular geographic region.

2. A computer-implemented method for identifying a recurrent query, comprising:
identifying, from a log of received queries, a plurality of queries related to a candidate recurrent query;
determining a plurality of counts from the plurality of queries, each count representing a number of times the queries were received from one of a plurality of geographic regions and during one of a plurality of time periods;
identifying a peak count among the plurality of counts, the peak count satisfying peak count criteria and representing a number of times the queries were received from a first geographic region during a first time period; and
determining that the candidate recurrent query is a recurrent query during the first time period for the first geographic region.

3. The method of claim 2, wherein identifying a peak count among the plurality of counts further comprises determining that a ratio of a count among the plurality of counts to the average count among the plurality of counts is greater than a threshold.

4. The method of claim 2, wherein identifying a peak count from among the plurality of counts further comprises:
determining a probability distribution from the plurality of counts, each probability in the probability distribution representing the probability of receiving queries from the plurality of queries from one of the plurality of geographic regions during one of the plurality of time periods;
determining that an entropy of the probability distribution exceeds a threshold; and
identifying a geographic region and a time period having a highest probability in the probability distribution.

5. The method of claim 2, wherein the plurality of queries are identical queries.

6. The method of claim 2, wherein the plurality of queries are similar queries.

7. The method of claim 2, wherein determining a plurality of counts comprises determining the counts at different levels of geographic region granularity or different levels of time period granularity.

8. The method of claim 2, further comprising:
receiving a search query from a client device;
determining that the search query is similar to the candidate recurrent query;
determining that the search query was received during the first period of time; and
determining that the client device is located in the first geographic region.

9. A system comprising:
one or more computers and one or more storage devices storing instructions that are operable, when executed by the one or more computers, to cause the one or more computers to perform operations comprising:
receiving a query from a client device;
determining that the query is a recurrent query, wherein a recurrent query is a query that is predominantly received from a particular geographic region during a particular time period; and
determining the location of the client device based at least in part on the particular geographic region.

10. A system comprising:
one or more computers and one or more storage devices storing instructions that are operable, when executed by the one or more computers, to cause the one or more computers to perform operations comprising:
identifying, from a log of received queries, a plurality of queries related to a candidate recurrent query;
determining a plurality of counts from the plurality of queries, each count representing a number of times the queries were received from one of a plurality of geographic regions and during one of a plurality of time periods;
identifying a peak count among the plurality of counts, the peak count satisfying peak count criteria and representing a number of times the queries were received from a first geographic region during a first time period; and
determining that the candidate recurrent query is a recurrent query during the first time period for the first geographic region.

11. The system of claim 10, wherein identifying a peak count among the plurality of counts further comprises determining that a ratio of a count among the plurality of counts to the average count among the plurality of counts is greater than a threshold.

12. The system of claim 10, wherein identifying a peak count from among the plurality of counts further comprises:
determining a probability distribution from the plurality of counts, each probability in the probability distribution representing the probability of receiving queries from the plurality of queries from one of the plurality of geographic regions during one of the plurality of time periods;
determining that an entropy of the probability distribution exceeds a threshold; and
identifying a geographic region and a time period having a highest probability in the probability distribution.

13. The system of claim 10, wherein the plurality of queries are identical queries.

14. The system of claim 10, wherein the plurality of queries are similar queries.

15. The system of claim 10, wherein determining a plurality of counts comprises determining the counts at different levels of geographic region granularity or different levels of time period granularity.

16. The system of claim 10, wherein the operations further comprise
receiving a search query from a client device;
determining that the search query is similar to the candidate recurrent query;
determining that the search query was received during the first period of time; and
determining that the client device is located in the first geographic region.
